(19) United States
(12) Patent Application Publication
(10) Pub. No.: US 2001/0037164 A1
(43) Pub. Date: Nov. 1, 2001

(54) Method and device for determining the buckling angle between a front vehicle and a semitrailer of a vehicle

(76) Inventor: Falk Hecker, Markgroeningen (DE)

Correspondence Address: KENYON & KENYON, ONE BROADWAY, NEW YORK, NY, 10004, US

(21) Appl. No.: 09/753,377

(22) Filed: Jan. 2, 2001

(30) Foreign Application Priority Data
Dec. 30, 1999 (DE) 199 64 059.9

(51) Int. Cl. G06F 17/00

(52) U.S. Cl. 701/1; 280/423.1

(57) ABSTRACT

A method and a device for determining a buckling angle between a front vehicle and a semitrailer or trailer of a motor vehicle is described. A first and a second electronic direction sensor are mounted on the front vehicle to detect the excursion of the longitudinal axis of the front vehicle about its vertical axis, as well as on the semitrailer or trailer to detect the excursion of the longitudinal axis of the semitrailer or trailer about its vertical axis. On the basis of the two values obtained by using the sensors indicating the absolute or relative vehicle orientation of the vehicle components, the buckling angle is determined. At least one of the two sensors is designed to detect the earth's magnetic field or, alternatively, is an inertia sensor.

### FIELD OF THE INVENTION

The present invention relates to a method and a device for determining a buckling angle between a front vehicle and a semitrailer or trailer of a motor vehicle.

### BACKGROUND INFORMATION

In German Patent No. 39 23 677, an angle sensor described therein senses the angle between the longitudinal axis of a tractor vehicle and a trailer, and the angle sensor is equipped with a potentiometer arranged on the tractor vehicle. The drive shaft of the potentiometer can be coupled to the trailer. The problem in measuring the buckling angle with such a conventional potentiometer sensor is that this sensor must be attached to both the tractor and trailer or semitrailer. Since the attachment on the semitrailer or trailer must be attached and detached every time the trailer is attached and detached and because, in addition, a corresponding mating device must be present on the semitrailer or trailer, this method is complicated and therefore impractical.

### SUMMARY OF THE INVENTION

An object of the present invention is to provide an improved method and an improved device for determining a buckling angle between a front vehicle and a semitrailer or trailer of a motor vehicle using electronic direction sensors.

Electronic direction sensors are defined for the purposes of the present invention as

1) inductive sensors with which the earth's magnetic field and thus the absolute orientation of the vehicle can be detected. Examples of such sensors include flux gate sensors, magneto-inductive sensors, or magneto-resistive sensors.

2) inertia sensors with which the relative vehicle orientation can be detected.

Examples include a gyro compass.

3) a sensor for detecting the yaw rate of a vehicle.

The term “front vehicle” is used at different points in the following. It is defined as the tractor vehicle of a tractor-trailer, and it can also be referred to as a tractor.

Thus the present invention relates to a method and a device for determining a buckling angle between a front vehicle and a trailer or semitrailer of a motor vehicle. The device includes a first sensor with which a value describing the excursion of the longitudinal axis of the front vehicle about its vertical axis can be obtained, the sensor being mounted on the front vehicle. An additional, i.e., second sensor with which a value describing the excursion of the longitudinal axis of the semitrailer or trailer about its vertical axis can be obtained is also included, the second sensor being mounted on the semitrailer or trailer.

The buckling angle being determined, i.e., calculated from the two values obtained using the sensors, and at least one of the two sensors is either a sensor for measuring the earth's magnetic field or an inertia sensor.

The advantages of the method according to the present invention and the device according to the present invention compared to the known methods and devices for determining the buckling angle between a front vehicle and a semitrailer or trailer of a motor vehicle are the following:

a) the present invention requires no additional mechanical connection between the front vehicle or tractor vehicle and the semitrailer or trailer, i.e., the measuring method is contactless;

b) no modification is required in the semitrailer or trailer;

c) the sensor system, when properly installed, is insensitive to contamination, mechanical damage and wear;

d) additional information concerning the absolute direction of travel of the vehicle, for example, for navigation systems, is available from the sensors;

e) existing direction sensors in the front vehicle, i.e., tractor, for example, sensors of the navigation system, can also be utilized; in this case only one additional sensor and the functional linkage of the signals generated by the sensors are used.

Of course, the method according to the present invention can be used not only in commercial vehicles having a tractor and a semitrailer or trailer, but also in other motor vehicles having a front vehicle and a trailer, for example in a passenger car connected to a trailer or a caravan. The present invention can also be used for multiple component vehicles having more than two vehicle components.

### BRIEF DESCRIPTION OF THE DRAWINGS

FIG. 1 shows a horizontal section of a vehicle composed of a front tractor vehicle and a semitrailer in order to elucidate the embodiments according to the present invention.

FIG. 2 schematically shows, in the form of a block diagram, a device suitable for carrying out the method according to an embodiment of the present invention.

### DETAILED DESCRIPTION

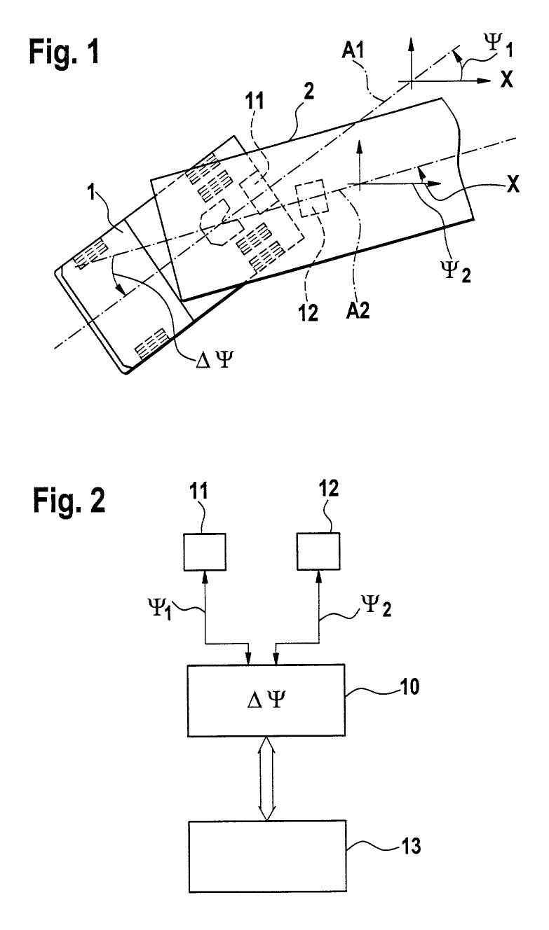

In FIG. 1, longitudinal axis A1 of a tractor vehicle 1 is offset with respect to a reference direction X by an angle ψ₁, while longitudinal axis A2 of a semitrailer 2 is offset with respect to the same reference direction X by an angle ψ₂. Reference direction X indicates, for example, the direction of the earth's magnetic field. A first sensor 11 for detecting vehicle orientation angle ψ₁, is mounted on front vehicle or tractor 1, and a second sensor 12 for measuring vehicle orientation angle ψ₂ of semitrailer 2 is mounted on semitrailer 2. Buckling angle Δψ can be calculated from the difference ψ₁−ψ₂.

For the following description of the embodiments it is assumed that the vehicle, comprising the tractor vehicle or front vehicle 1 and the semitrailer 2, is located, i.e. is moving, on a plane surface and that both sensors 11 and 12 are or can be oriented horizontally.

I. Measurement of the absolute vehicle orientations, i.e., angles ψ₁ and ψ₂ of the individual vehicles, i.e., of tractor vehicle 1 and trailer 2, with the help of the earth's magnetic field using flux gate sensors, magneto-inductive sensors, magneto-resistive sensors, or the like. Buckling angle Δψ corresponds, as mentioned previously, to the difference between the two vehicle angles:

Δψ=ψ₁−ψ₂

The value of the buckling angle measured in this driving situation is advantageously checked for plausibility in certain time intervals as the vehicle moves in a straight line. When the vehicle moves in a straight line, the buckling angle is expected to have a value zero. Thus if a value different from zero is obtained during travel in a straight line, this indicates an error caused by external influences during the measurement of the absolute vehicle orientation. In order to take into account or compensate for such interfering influences in determining the buckling angle, the determined value that is different from zero is stored and subtracted from the values for the buckling angles subsequently determined in other driving situations.

II. Measurement of the relative vehicle orientations of the individual vehicles using inertia sensors, for example, gyro compasses or inertia platforms or the like. Here too, buckling angle Δψ is calculated according to the above equation from the difference of the two vehicle angles ψ₁−ψ₂; the two vehicle angles ψ₁, ψ₂ are to be compensated in straight-line travel.

Compensation is required for the following reason: by detecting relative orientations for the two individual vehicles, different vehicle angles may result despite the same orientation of the two vehicle components, as may occur, for example, during straight-line travel, although both longitudinal axes of the individual vehicles are equally oriented in this driving situation, i.e., have the same direction. If no compensation is carried out, a buckling angle would be determined, for example, for straight-line travel, although no buckling angle may be present in this vehicle situation. Consequently, compensation is carried out in certain time intervals during straight-line travel. For this purpose, the buckling angle is determined from the two relative vehicle orientations. The value obtained for the buckling angle, which approximately represents the system-dependent offset, i.e., error, is stored. The stored value is subtracted from the value of the buckling angle determined for any driving situation. Thus the actual buckling angle, after correction with the offset, is obtained after subtraction for any driving situation.

III. The simultaneous use of the above embodiments I and II, i.e., for example, the measurement of the absolute vehicle orientation via angle ψ₂ of semitrailer 2 and the relative vehicle orientation of tractor vehicle or front vehicle 1. The sensor for relative measurements is compensated again and again, if necessary, in order to compensate for offset errors in appropriate driving situations, such as, for example, straight-line travel, with the help of the sensor for absolute measurements. Buckling angle Δψ is calculated according to the above equation from the difference between the two vehicle orientation angles ψ₁ and ψ₂.

Also in the case of this sensor combination, the buckling angle should have a zero value in straight-line travel. Since the relative vehicle orientation of the tractor vehicle is taken into account, however, a buckling angle different from zero may occur. This offset is determined according to Example II and taken into account in determining the buckling angle in any desired driving situation.

IV. Measurement of the absolute vehicle orientation ψ₂ of semitrailer 2 and determination of the vehicle orientation of the tractor vehicle by integrating the measured yaw rate ω_{z} of tractor vehicle 1:

ψ₁=∫ω_{z}+k.

The integrated yaw rate ω_{z} is compensated again and again with the measured vehicle orientation ψ₂ of the semitrailer using constant k to avoid offset errors. The compensation is performed in appropriate driving situations such as, for example, in uncritical straight-line travel. This means that in the case of this sensor combination, an offset determined in straight-line travel is taken into account in integrating the yaw rate in the form of factor k. Buckling angle Δψ is then determined according to the above equation from the difference between ψ₁ and ψ₂.

FIG. 2 shows a device designed for carrying out the above exemplary methods. Vehicle orientation signals ψ₁ and ψ₂ from sensor 11 of front vehicle 1 and sensor 12 of semitrailer 2, respectively, are supplied to a processing unit 10 set up to calculate the buckling angle as a function of vehicle orientation signals ψ₁ and ψ₂ received by the two sensors, in particular to form the difference ψ₁−ψ₂ Processing unit 10 can also compensate sensors 11 and 12 as needed in some of the above embodiments. Furthermore, processing unit 10 can also be functionally connected to additional sensors in the vehicle and also to an input/output unit 13, such as, for example, a keyboard and display or a controller in the vehicle. Processing unit 10 can either be a separate unit containing a programmed microprocessor, for example, or part of a processing unit already present in the vehicle.

The above-mentioned controller can be a slip controller, for example, with which the brake slip or the drive slip or the yaw rate, at least of the tractor vehicle, is controlled.

We shall point out the different sensor combinations here again. Two inductive sensors with which the earth's magnetic field is evaluated or two inertia sensors or one inductive sensor and one inertia sensor or one inductive sensor and one yaw rate sensor can be used.

The sensors can be advantageously integrated in a connecting cable mounted between the tractor vehicle and the semitrailer or trailer. This connecting cable may be the ABS connecting cable (ISO standard 7638) or a compressed air line, for example. In embodiments I through III, one sensor is mounted in the semitrailer-side connector and one sensor in the tractor-side connector. In embodiment IV, the sensor for absolute measurements is built into the semitrailer-side connector. Any other installation sites in the individual vehicles are conceivable, as long as the horizontal orientation of the sensors is observed.

What is claimed is:

1. A method for determining a buckling angle between a front vehicle and one of a semitrailer and a trailer of a motor vehicle, comprising the steps of:
causing at least one electronic direction sensor to measure a first vehicle orientation indicating a first excursion of a longitudinal axis of the front vehicle about a vertical axis of the front vehicle;
causing at least one additional electronic direction sensor to measure a second vehicle orientation indicating a second excursion of a longitudinal axis of the one of the semitrailer and the trailer about a vertical axis of the one of the semitrailer and the trailer; and
determining the buckling angle by evaluating a measurement of the first vehicle orientation and a measurement of the second vehicle orientation.

2. The method according to claim 1, wherein:
the first vehicle orientation corresponds to a first absolute vehicle orientation,
the second vehicle orientation corresponds to a second absolute orientation,
the measurement of the first absolute vehicle orientation and the measurement of the second absolute vehicle orientation are performed in accordance with a magnetic field of the earth, and
the step of determining the buckling angle includes the step of calculating a difference between the first absolute vehicle orientation and the second absolute vehicle orientation vehicle orientation.

3. The method according to claim 1, wherein
the first vehicle orientation corresponds to a first relative vehicle orientation,
the second vehicle orientation corresponds to a second relative vehicle orientation, and
the step of determining the buckling angle includes the step of measuring a difference between the first relative vehicle orientation and the second relative vehicle orientation, the first relative vehicle orientation and the second relative vehicle orientation being compensated in a straight-line travel.

4. The method according to claim 1, wherein:
the first vehicle orientation corresponds to a first relative vehicle orientation;
the second vehicle orientation corresponds to a second absolute vehicle orientation and is measured in accordance with a magnetic field of the earth; and
the step of determining the buckling angle includes the step calculating a difference between the first relative vehicle orientation and the second absolute vehicle orientation.

5. The method according to claim 1, wherein:
the first vehicle orientation corresponds to a first absolute vehicle orientation;
the second vehicle orientation corresponds to a second relative vehicle orientation; and
the step of determining the buckling angle includes the step of calculating a difference between the first absolute vehicle orientation and the second relative vehicle orientation, the difference being compensated in a straight-line travel.

6. The method according to claim 4, further comprising the step of:
compensating a measurement result relating to the measurement of the first relative vehicle orientation in a driving situation in accordance with the measurement of the second absolute vehicle orientation to compensate for an offset error.

7. The method according to claim 5, further comprising the step of:
compensating a measurement result relating to the measurement of the second relative vehicle orientation in a driving situation in accordance with the measurement of the first absolute vehicle orientation to compensate for an offset error.

8. The method according to claim 1, wherein the front vehicle includes a tractor vehicle, and wherein the method further comprises the steps of:
integrating a measured yaw rate (ω_{z}) of the tractor vehicle according to the following equation:
ψ₁=∫ω_{z}.dt+k,
deriving an integrated yaw rate;
determining a relative first vehicle orientation from the integrated yaw rate;
determining an absolute second vehicle orientation from the integrated yaw rate; and
compensating a constant k of the integrated yaw rate with the measured second vehicle orientation in a driving situation to avoid an offset error,
wherein the step of determining the buckling angle includes the step of calculating a difference between the relative first vehicle orientation and the absolute second vehicle orientation.

9. A device for determining a buckling angle between a front vehicle and one of a semitrailer and a trailer of a motor vehicle, the buckling angle indicating an excursion of a longitudinal axis of the front vehicle about a vertical axis of the front vehicle with respect to an excursion of a longitudinal axis of the one of the semitrailer and the trailer about a vertical axis of the one of the semitrailer and the trailer, comprising:
a first electronic direction sensor, mounted on the front vehicle, with which a first vehicle orientation signal indicating the excursion of the longitudinal axis of the front vehicle about the vertical axis thereof can be obtained;
a second electronic direction sensor, mounted on the one of the semitrailer and the trailer and independent of the first electronic direction sensor, with which a second vehicle orientation signal indicating the excursion of the longitudinal axis of the one of the semitrailer and the trailer about the vertical axis thereof can be obtained; and
a processing unit functionally connected to the first electronic direction sensor and the second electronic direction sensor and for determining the buckling angle as a function of the first vehicle orientation signal and the second vehicle orientation signal received respectively by the first electronic direction sensor and the second electronic direction sensor.

10. The device according to claim 9, wherein the first electronic direction sensor and the second electronic direction sensor measure an absolute first vehicle orientation signal and an absolute second vehicle orientation signal, respectively, in accordance with a magnetic field of the earth, and the processing unit determines the buckling angle by forming a difference between the absolute first vehicle orientation signal and the absolute second vehicle orientation signal.

11. The method according to claim 10, wherein at least one of the first electronic direction sensor and the second electronic direction sensor includes one of a flux gate sensor, a magneto-inductive sensor, and a magneto-resistive sensor.

12. The device according to claim 9, wherein each one of the first electronic direction sensor and the second electronic direction sensor includes an inertia sensor, each inertia sensor including a gyro compass, each inertia sensor measuring respectively a relative first vehicle orientation and a relative second vehicle orientation, and wherein the processing unit determines the buckling angle from a difference between the relative first vehicle orientation and the relative second vehicle orientation, the processing unit compensating the relative first vehicle orientation and the relative second vehicle orientation in a straight-line travel.

13. The device according to claim 9, wherein one of the first electronic direction sensor and the second electronic direction sensor measures an absolute vehicle orientation of a vehicle component, wherein another one of the first electronic direction sensor and the second electronic direction sensor measures a relative vehicle orientation of another vehicle component, and wherein the processing unit determines the buckling angle from a difference between the absolute vehicle orientation and a relative vehicle orientation, the processing unit compensating the absolute vehicle orientation and the relative vehicle orientation in a straight-line travel.

14. The device according to claim 13, wherein the processing unit compensates the other one of the first electronic direction sensor and the second electronic direction sensor that measures the relative vehicle orientation to compensate for an offset error in accordance with the one of the first electronic direction sensor and the second electronic direction sensor that measures the absolute vehicle orientation in a driving situation.

15. The device according to claim 9, wherein an absolute second vehicle orientation signal is detected by the second electronic direction sensor which measures a magnetic field of the earth, and the front vehicle includes an arrangement for measuring a yaw rate (ω_{z}) of the front vehicle, the processing unit calculating a first vehicle orientation of the front vehicle by integrating the measured yaw rate (ω_{z}) of the front vehicle according to the following equation:
ψ₁=∫ω_{z}.dt+k.

16. The device according to claim 15, wherein the processing unit compensates an integrated yaw rate using a constant k to avoid an offset error with a measured signal corresponding to the second absolute vehicle orientation signal of the one of the semitrailer and the trailer.

17. The device according to claim 15, wherein the processing unit performs the compensation in a driving situation including a straight-line travel and determines the buckling angle by determining a difference between the first vehicle orientation signal and the second vehicle orientation signal.

18. The device according to claim 9, wherein the first electronic direction sensor and the second electronic direction sensor are horizontally oriented.
